(19) United States
(12) Patent Application Publication
(10) Pub. No.: US 2025/0056400 A1
(43) Pub. Date: Feb. 13, 2025

(54) EXTENSIBLE COVERAGE ENHANCEMENT CELL ACCESS THRESHOLDS

(71) Applicant: Telefonaktiebolaget LM Ericsson (publ), Stockholm (SE)

(72) Inventors: Jonas SEDIN, Brentford (GB); Tuomas TIRRONEN, Helsinki (FI)

(21) Appl. No.: 18/722,758

(22) PCT Filed: Dec. 23, 2022
(86) PCT No.: PCT/IB2022/062743

§ 371 Date: Jun. 21, 2024

Related U.S. Application Data
(60) Provisional application No. 63/293,496, filed on Dec. 23, 2021.

(51) Int. Cl. H04W 48/20; H04W 36/00

(52) U.S. Cl. CPC H04W 48/20; H04W 36/00837

(57) ABSTRACT

Systems and methods for configuring cell selection and access are provided. A wireless device can receive configuration information, from a network node, including a plurality of cell access threshold parameters, wherein each parameter indicates a cell access threshold for at least one feature. The wireless device can determine that a first feature associated with a first cell access threshold parameter is supported by the wireless device and select a cell for access accordingly.

### CROSS REFERENCE TO RELATED APPLICATIONS

This application claims the benefit of U.S. Provisional Application No. 63/276,293 filed on Dec. 23, 2021, the entire contents of which are hereby incorporated by reference.

### TECHNICAL FIELD

The present disclosure generally relates to wireless communications and wireless communication networks.

### INTRODUCTION

Standardization bodies such as Third Generation Partnership Project (3GPP) are studying potential solutions for efficient operation of wireless communication in new radio (NR) networks. The next generation mobile wireless communication system 5G/NR will support a diverse set of use cases and a diverse set of deployment scenarios. The later includes deployment at both low frequencies (e.g. 100s of MHz), similar to LTE today, and very high frequencies (e.g. mm waves in the tens of GHz).

Besides the typical mobile broadband use case, NR is being developed to also support machine type communication (MTC), Narrow Band-Internet of Things (NB-IoT), ultra-low latency critical communications (URLCC), enhanced Mobile Broadband (eMBB), side-link device-to-device (D2D) and other use cases. Example requirements of the devices targeting the connected industries are lower device complexity, compact device size, and support for FR1/FR2 bands in frequency division duplex (FDD) and time division duplex (TDD) transmission modes. Power Savings, lower capability, and coverage enhancements are coupled in terms of improving the spectrum efficiency and performance of the NR networks.

In RAN #90e, the following objectives have been approved for NR coverage enhancement work item in NR Rel-17 for PUSCH.

### Specification of PUSCH Enhancements [RAN1, RAN4]

Specify the following mechanisms for enhancements on PUSCH repetition type A [RAN1]: Increasing the maximum number of repetitions up to a number to be determined during the course of the work. The number of repetitions counted on the basis of available UL slots.
Specify mechanism(s) to support TB processing over multi-slot PUSCH [RAN1]: TBS determined based on multiple slots and transmitted over multiple slots.
Specify mechanism(s) to enable joint channel estimation [RAN1, RAN4]: Mechanism(s) to enable joint channel estimation over multiple PUSCH transmissions, based on the conditions to keep power consistency and phase continuity to be investigated and specified if necessary by RAN4 [RAN1, RAN4](Potential optimization of DMRS location/granularity in time domain is not precluded). Inter-slot frequency hopping with inter-slot bundling to enable joint channel estimation [RAN1].

### Specification of PUCCH Enhancements [RAN1, RAN4]

Specify signaling mechanism to support dynamic PUCCH repetition factor indication [RAN1].
Specify mechanism to support DMRS bundling across PUCCH repetitions [RAN1, RAN4].

### Specification of Mechanism(s) to Support Type A PUSCH Repetitions for Msg3 [RAN1]

Two types of random-access procedures are supported in NR up to Release 16, where a MsgA PUSCH or a Msg3 PUSCH transmission are used for transmission of RRC setup request message in 2-step RACH RA type and 4-step RA type respectively. Neither Msg3 PUSCH nor MsgA PUSCH can be repeated in NR up to Release 16.

### 4-Step Random Access Procedure in NR

FIG. 1 illustrates a 4-step approach used for the random access procedure. In this approach, the UE detects a synchronization signal (SS) and decodes the broadcasted system information (which may be distributed over multiple physical channels, PBCH and PDSCH) to acquire random access transmission parameters, followed by transmitting a PRACH preamble (message 1) in the uplink.

The gNB detects message 1 and replies with a RAR message (Random Access Response, message 2). The UE then transmits a UE identification (message 3) on PUSCH. The UE transmits PUSCH (message 3) after receiving a timing advance command in the RAR and after adjusting the timing of the PUSCH transmission, allowing PUSCH to be received at gNB with a timing accuracy within the cyclic prefix. Without this timing advance functionality, a very large cyclic prefix would be needed in order to be able to demodulate and detect PUSCH, unless the system is applied in a cell with very small distance between UE and gNB. Since NR will also support larger cells, there is a need for providing a timing advance to the UE and thus the 4-step approach is needed for random access procedure.

### Random Access for Msg3 Repetitions

During the discussions in the meetings from RAN1 #104-e, the first meeting of the NR coverage enhancement work item in Rel-17, to RAN1 #105-e, following Agreements have been made regarding the Msg3 repetition criteria:
UE determines a separate PRACH resource (separate preamble or separate PRACH occasions) based at least on RSRP of the downlink pathloss reference and the RSRP threshold
Based on the PRACH resource on which a PRACH is detected, gNB is aware of whether a Msg3 repetition can be enabled for the UE sending this PRACH.

For Msg3 PUSCH repetition, support the following modified Option 2-1.

Option 2-1: For UE requested Msg3 PUSCH repetition with gNB indicating the number of repetitions,
A UE can request Msg3 PUSCH repetition via separate PRACH resources (FFS details, e.g., separate PRACH occasion or separate PRACH preamble in case of shared PRACH occasions after SSB association, etc.).
Whether a UE would request is based on some conditions, e.g., measured SS-RSRP threshold, which may or may not have spec impact.
If Msg3 PUSCH repetition is requested by UE, gNB decides whether to schedule Msg3 PUSCH repetition or not. If scheduled, gNB decides the number of repetitions for Msg3 PUSCH 3 (re)-transmission.
FFS the UE capability of supporting Msg3 PUSCH repetition can be reported after initial access procedure as usual
FFS details if any.

A UE requests Msg3 PUSCH repetition at least when the RSRP of the downlink pathloss reference is lower than an RSRP threshold.
FFS the determination of the RSRP threshold.

For requesting Msg3 PUSCH repetition, support the following:
Use separate preamble with shared RO configured by the same PRACH configuration index with legacy UEs:
FFS whether to introduce a PRACH mask to indicate a sub-set of ROs associated with a same SSB index within an SSB-RO mapping cycle for requesting Msg3 repetition for a UE.
FFS definition of shared RO (e.g., whether the shared RO can be an RO with preamble(s) for 4-step RACH only or with preambles for both 4-step RACH and 2-step RACH).
FFS whether or not to additionally support one (& only one) more option:
E.g., option 2: Use separate RO configured by a separate PRACH configuration index from legacy UEs
E.g., Option 3: Use separate RO, which include:
the separate RO configured by a separate RACH configuration index from legacy UE, and
the remaining RO (if any) configured, by the same PRACH configuration index with legacy UEs, that cannot be used by legacy rules for PRACH transmission.

### NR Idle Mode Cell Selection Re-Selection

Cell selection and cell re-selection are used by a UE to select an NR cell in different scenarios. The cell selection is used to select an acceptable cell in certain scenarios such as after the UE has been powered on or if no information currently exists.

Cell re-selection is used by the UE to re-evaluate the cells to for instance see if the current cell is where the UE shall be camped on or not, thus it is the most crucial procedure for UE to perform mobility when the UE is in idle mode. In the cell re-selection procedure, the UE must evaluate whether the cells are suitable through the cell selection condition. The cell selection condition checks whether a cell is suitable only, and then the cell ranking criteria or priorities in the frequencies is used to determine whether one cell shall be selected over another one.

Cell selection criteria is defined as below. One instance where in the cell selection procedure the UE has different thresholds is if the UE supports SUL and the network has configured the parameter q-RxLevMinSUL, which is broadcasted among other cell selection parameters in SIB1 or in SIB2/SIB4 for neighbouring cells. This is needed as the SUL carrier is supposed to be able to provide better coverage, thus it is needed so that the minimum supported level shall be able to smaller.

The cell selection criterion S is fulfilled when:

$$Srxlev > 0 AND Squal > 0$$

where:

$$Srxlev = {Q}_{rxlevmeas} - ( {Q}_{rxlevmin} + {Q}_{rxlevminoffset} ) - {P}_{compensation} - {Qoffset}_{temp} \\ Squal = {Q}_{qualmeas} - ( {Q}_{qualmin} + {Q}_{qualminoffset} ) - {Qoffset}_{temp}$$

where:

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 |
| | [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports SUL frequency for this cell, Qᵣₓₗₑᵥₘᵢₙ is obtained from |
| | q-RxLevMinSUL, if present, in SIB1, SIB2 and SIB4, |
| | additionally, if Q_{rxlevminoffsetcellSUL} is present in SIB3 and SIB4 for |
| | the concerned cell, this cell specific offset is added to the |
| | corresponding Qrxlevmin to achieve the required minimum RX |
| | level in the concerned cell; |
| | else Qᵣₓₗₑᵥₘᵢₙ is obtained from q-RxLevMin in SIB1, SIB2 and |
| | SIB4, additionally, if Q_{rxlevminoffsetcell} is present in SIB3 and SIB4 |
| | for the concerned cell, this cell specific offset is added to the |
| | corresponding Qrxlevmin to achieve the required minimum RX |
| | level in the concerned cell. |
| Q_{qualmin} | Minimum required quality level in the cell (dB). Additionally, if |
| | Q_{qualminoffsetcell} is signalled for the concerned cell, this cell |
| | specific offset is added to achieve the required minimum |
| | quality level in the concerned cell. |
| Q_{rxlevminoffset} | Offset to the signalled Qrxlevmin taken into account in the Srxlev |
| | evaluation as a result of a periodic search for a higher priority |
| | PLMN while camped normally in a VPLMN, as specified in TS |
| | 23.122 [9]. |
| Q_{qualminoffset} | Offset to the signalled Q_{qualmin} taken into account in the Squal |
| | evaluation as a result of a periodic search for a higher priority |
| | PLMN while camped normally in a VPLMN, as specified in TS |
| | 23.122 [9]. |
| P_{compensation} | For FR1, if the UE supports the additionalPmax in the NR-NS- |
| | PmaxList, if present, in SIB1, SIB2 and SIB4: |
| | max(PEMAX1 -PPowerClass, 0) − (min(P_{EMAX2}, P_{PowerClass}) − |
| | min(P_{EMAX1} − P_{PowerClass})) (dB); |
| | else: |
| | max(P_{EMAX1} − P_{PowerClass}, 0) (dB) |
| | For FR2, P compensation is set to 0. |
| P_{EMAX1}, P_{EMAX2} | Maximum TX power level of a UE may use when transmitting |
| | on the uplink in the cell (dBm) defined as P_{EMAX} in TS 38.101 |
| | [15]. If UE supports SUL frequency for this cell, PEMAX1 and |
| | P_{EMAX2} are obtained from the p-Max for SUL in SIB1 and NR- |
| | NS-PmaxList for SUL respectively in SIB1, SIB2 and SIB4 as |
| | specified in TS 38.331 [3], else P_{EMAX1} and P_{EMAX2} are obtained |
| | from the p-Max and NR-NS-PmaxList respectively in SIB1, |
| | SIB2 and SIB4 for normal UL as specified in TS 38.331 [3]. |
| P_{PowerClass} | Maximum RF output power of the UE (dBm) according to the |
| | UE power class as defined in TS 38.101-1 [15]. |

### SUMMARY

It is an object of the present disclosure to obviate or mitigate at least one disadvantage of the prior art.

There are provided systems and methods for configuring cell selection and access.

In a first aspect there is provided a method performed by a wireless device. The wireless device can comprise a radio interface and processing circuitry and be configured to receive configuration information including a plurality of cell access threshold parameters. Each of the parameters indicates a cell access threshold for at least one feature. The wireless device determines that a first feature associated with a first cell access threshold parameter is supported by the wireless device. The wireless device selects a cell in accordance with the first cell access threshold parameter.

In some embodiments, the configuration information is received in a system information message. In some embodiments, the configuration information is received in a UE-specific radio resource control (RRC) message.

In some embodiments, the first cell access threshold parameter is associated with at least one of: a minimum signal strength allowed on the cell, and a minimum signal quality allowed on the cell. In some embodiments, the first cell access threshold parameter is associated with at least one of: a number of repetitions of a message within a random access procedure, a number of repetitions of message in a channel outside of random access, a wireless device type, and a supplementary uplink (SUL) access threshold.

In some embodiments, the first cell access threshold parameter is an offset value.

In some embodiments, multiple features are associated with the first cell access threshold parameter. Each of the multiple features can be associated with multiple (e.g. different) specification releases.

In some embodiments, the step of determining that the first feature associated with the first cell access threshold parameter is supported by the wireless device can include comparing the received plurality of cell access threshold parameters to a set of supported features of the wireless device.

In some embodiments, the wireless device determines that multiple cell access threshold parameters are supported by the wireless device. The wireless device can further select the first cell access threshold parameter from the multiple supported cell access threshold parameters. In some embodiments, the first cell access threshold parameter is selected in accordance with one or more of: a priority order, in accordance with the first cell access threshold parameter having a highest value such that a condition is fulfilled, a traffic requirement, a power consumption requirement, and/or a reliability requirement.

In some embodiments, the step of selecting the cell can include evaluating the cell with respect to the first cell access threshold parameter; and accessing the cell.

In another aspect, there is provided a method performed by a network node. The network node can comprise a radio interface and processing circuitry and be configured to generate configuration information including a plurality of cell access threshold parameters, wherein each parameter indicates a cell access threshold for at least one feature. The network node transmits, to a wireless device, the configuration information including a plurality of cell access threshold parameters.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example 4-step approach for random access;

FIG. 2 is an example communication system;

FIG. 3 is a flow chart illustrating a method performed by a wireless device;

FIG. 4 is a flow chart illustrating a method performed by a network node;

FIG. 5 is a block diagram of an example wireless device;

FIG. 6 is a block diagram of an example network node;

FIG. 7 is a block diagram of an example host;

FIG. 8 is a block diagram illustrating an example virtualization environment; and

FIG. 9 is a communication diagram of a host communicating via a network node with a UE.

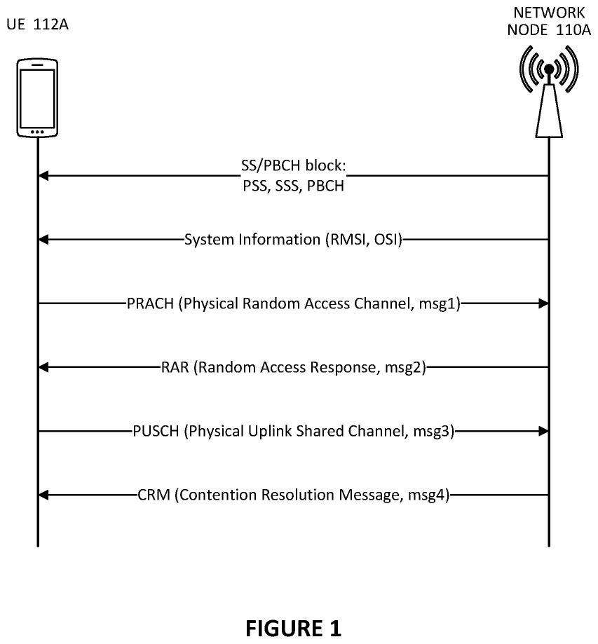

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

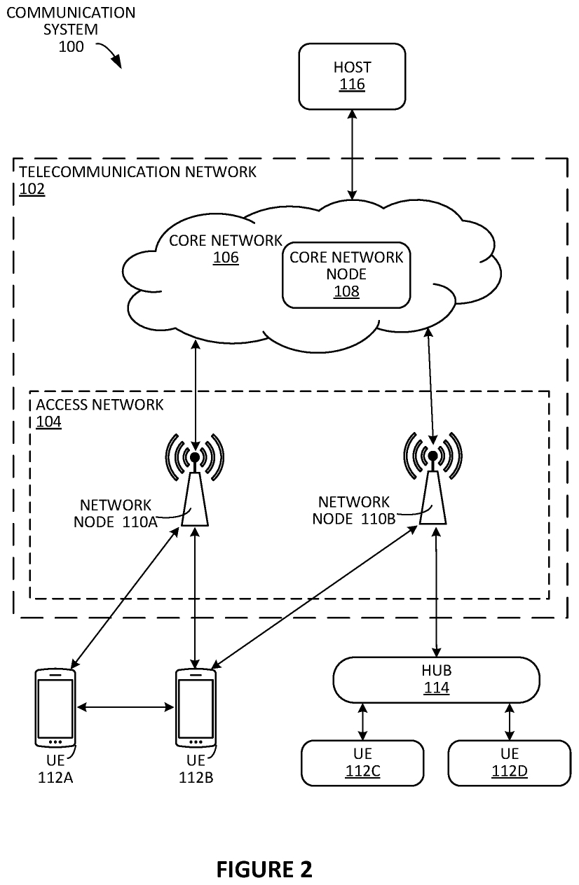

FIG. 2 illustrates an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110A and 110B (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112A, 112B, 112C, and 112D (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one or more core network nodes (e.g. core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Location Management Function (LMF), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g. 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 114 communicates with the access network 104 to facilitate indirect communication between one or more UEs (e.g. UE 112C and/or 112D) and network nodes (e.g. network node 110B). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110B. The hub 114 may also allow for a different communication scheme and/or schedule between the hub 114 and UEs (e.g. UE 112C and/or 112D), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110B. In other embodiments, the hub 114 may be a non-dedicated hub—that is, a device which is capable of operating to route communications between the UEs and network node 110B, but which is additionally capable of operating as a communication start and/or end point for certain data channels.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”. However, particularly with respect to 5G/NR concepts, beams may be used instead of cells and, as such, it is important to note that the concepts described herein are equally applicable to both cells and beams.

Returning to the discussion of cell selection and access, in 3GPP RAN #94e meeting the following is a part of the Work Item Description for Rel-18:

Specify following PRACH coverage enhancements (RAN1, RAN2)
Multiple PRACH transmissions with same beams for 4-step RACH procedure.
Study, and if justified, specify PRACH transmissions with different beams for 4-step RACH procedure
Note 1: The enhancements of PRACH are targeting for FR2, and can also apply to FR1 when applicable.
Note 2: The enhancements of PRACH are targeting short PRACH formats, and can also apply to other formats when applicable.

In RAN2 #115-e it was discussed whether new cell access thresholds shall be introduced due to introduction of Msg3-repetitions, where the proposal was to introduce new q-RxLevMin. This was proposed in 3GPP contribution R2-2107745, “Consideration on Msg3 repetition in CE”, ZTE, RAN2 #115-e, August 2021. The reason for the introduction is that Msg3 repetitions increases the uplink coverage, which means that when certain cells shall be selected, the cells that support Msg3 repetitions should have increased coverage reflected in the cell access thresholds.

However, a potential problem with the above approach is that the coverage extension of only Msg3 is in fact not very big. Another problem is that there will possibly be new features standardized in the future, such as Msg1 repetitions (expected to be introduced in Rel-18 according to the WID above). If the same approach is taken for these, then there will have to be new thresholds each time new repetitions are standardized or extended. This means that if the maximum amount of Msg3 repetitions is extended, for instance, a new cell access threshold may need to be introduced, because the network would not know if the UEs support the previous or the new maximum number of repetitions. Furthermore, it will not be clear how to for instance apply multiple thresholds—for instance how the cell access thresholds for SUL and Msg3 are combined (if Msg3-based cell access thresholds are introduced that is). The new features and possible new thresholds can be added in new version of the specifications, on top of what already exist. Thus, specification-wise, it can become challenging to specify the combinations, and if not careful it would also be difficult for the network to know what thresholds are being applied due to different capabilities of the devices.

3GPP specifications refer to “Feature Sets” as a set of features that the UE supports on the carriers corresponding to one band entry in a band combination. A “feature” can be, for example, any function/aspect that the UE indicates support for using capability signaling. 3GPP TS 38.331 and TS 38.306, for example, describe specific capabilities and signaling. There are also features/capabilities which are assumed to be supported by all UEs (e.g. without capability signaling).

Furthermore, in several other work items such as in Rel-17 reduced capability NR UEs (RedCap), changes to cell selection/re-selection to have the UE prioritize certain cells have been considered, but these are usually problematic as they would have to be combined with other cell access thresholds.

Accordingly, some details are required to be introduced to avoid the specification impacts of multiple cell access thresholds from different releases. Some embodiments described herein include methods for introducing cell access threshold(s) that can be combined with multiple features. A UE can receive and apply cell selection parameters for evaluating cells in idle mode.

Some embodiments can define a set of conditions for the UE to determine that a cell is suitable, including:

1. Methods for a UE to perform cell selection where the UE:
UE receives cell access threshold(s) of a cell from the network where each threshold indicates the cell access threshold for one or more features;
UE evaluates which features are supported and selects the suitable cell access threshold;
UE evaluates whether the cell is suitable.

2. Methods for a UE to perform cell selection, where the cell access threshold applies to at least one of the following:
A repetition number of a message within random access procedure (msg1, msg2, msg3, msg4);
a specific feature;
a specific UE type;
supplementary uplink (SUL);
future extension.

3. Methods for a UE to perform cell selection, where the cell access threshold is a minimum signal strength allowed on the cell.

4. Methods for a UE to perform cell selection, where the cell access threshold is a minimum signal quality allowed on the cell.

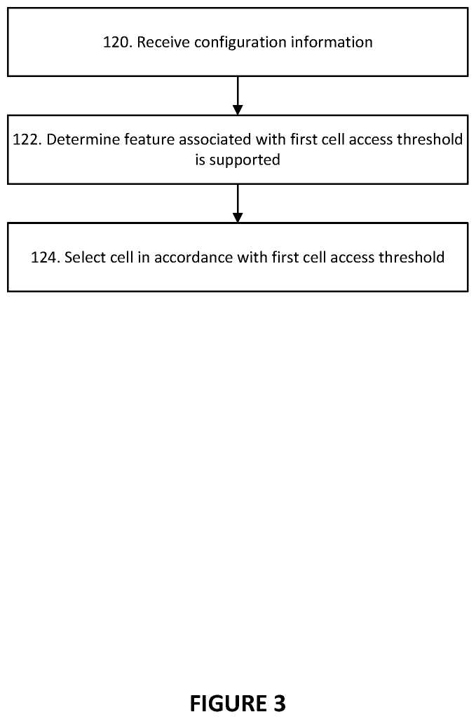

FIG. 3 is a flow chart illustrating a method which can be performed in a wireless device, such as a UE 112 as described herein. The method can include:

Step 120: The wireless device receives configuration information and applies cell access configuration. The configuration information can include one or more cell access threshold parameter(s) that each apply to one or more features.

The configuration information can be received via system information such as a system information block (SIB) message (e.g. SIB1, SIB2, SIB3, etc.). In some embodiments, the configuration information can be broadcast (e.g. to multiple UEs). In some embodiments, the configuration information can be received in UE-specific message.

In some embodiments, a cell access threshold parameter can be signaled as an absolute value. In other embodiments, a cell access threshold parameter can be signaled as an offset value.

Step 122: The wireless device determines that a feature associated with a first cell access threshold parameter is supported by the wireless device. The wireless device can compare its set of supported features with the features signaled (e.g. with new threshold parameters) to select the first cell access threshold.

In some embodiments, multiple features can be associated with one of the cell access threshold parameters. Each of the multiple features can be associated with one or more (e.g. different) specification release(s).

In some embodiments, the wireless device can determine that multiple cell access threshold parameters and/or features are supported by the wireless device. The wireless device can select the first cell access threshold from the multiple supported parameters.

Step 124: The selected cell access threshold is applied/evaluated for determining cell suitability (or whether a group of cells are suitable) for access. The wireless device can then access the cell in accordance with its determined suitability.

It will be appreciated that in some embodiments, the wireless device can communicate (e.g. transmit/receive messages) directly with a network node such as core network node 108. In other embodiments, messages and signals between the entities may be communicated via other nodes, such as radio access node (e.g. gNB, eNB) 110.

It will be appreciated that one or more of the above steps can be performed simultaneously and/or in a different order. Also, steps illustrated in dashed lines are optional and can be omitted in some embodiments.

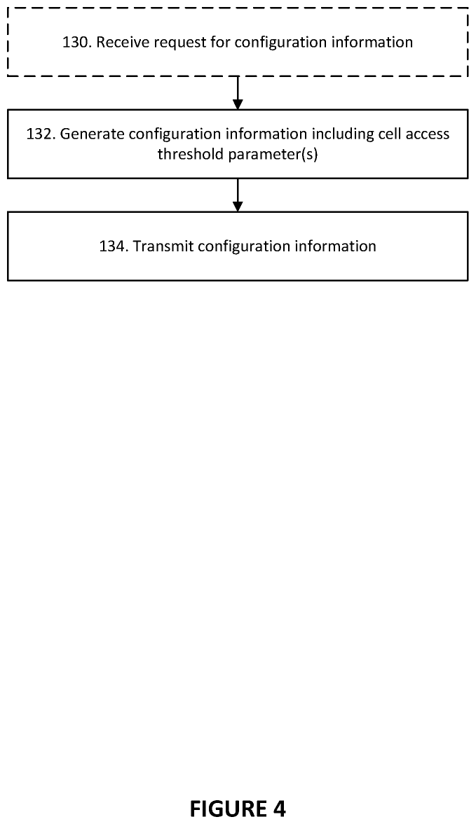

FIG. 4 is a flow chart illustrating a method which can be performed in a network node, such as gNB 110 and/or a core network node 108 as described herein. The method can include:

Step 130: Optionally, the network node receives a request for configuration information. The request can be received from one or more wireless device(s).

Step 132: The network node generates configuration information. The configuration information can include one or more cell access threshold parameter(s) associated with at least one cell, wherein each parameter indicates a cell access threshold for at least one feature. In some embodiments, each parameter can indicate a cell access threshold for one or more features associated with the cell.

Step 134: The network node transmits the generated configuration information. The configuration information can be transmitted to one or more wireless device(s). The configuration information can be transmitted via system information broadcast and/or UE-specific signaling.

It will be appreciated that in some embodiments, the wireless device can communicate (e.g. transmit/receive messages) directly with a network node such as core network node 108. In other embodiments, messages and signals between the entities may be communicated via other nodes, such as radio access node (e.g. gNB, eNB) 110.

It will be appreciated that one or more of the above steps can be performed simultaneously and/or in a different order. Also, steps illustrated in dashed lines are optional and can be omitted in some embodiments.

In some embodiments, these methods can be extended by signaling multiple blocks from multiple releases and combining them.

In some embodiments, the signaling can be transmitted in system information blocks for serving, inter and intra-frequency neighbors. In one example embodiment, this can be implemented using the Q-RxLevMinEnhanced information element (IE) from 3GPP TS 38.331.

The IE Q-RxLevMin is used to indicate for cell selection/re-selection the required minimum received RSRP level in the (NR) cell. Corresponds to parameter Qᵣₓₗₑᵥₘᵢₙ in TS 38.304. Actual value Qᵣₓₗₑᵥₘᵢₙ=field value*2 [dBm].

### Q-RxLevMinEnhanced Information Element

| | |
|---|---|
| -- ASN1START | |
| -- TAG-Q-RXLEVMIN-START | |
| Q-RxLevMinEnhanced-r17 ::= | SEQUENCE { |
| q-RxLevMinValue-r17 | INTEGER (-70..-22) |
| applicableFeatures-r17 | ApplicableFeatures-r17 |
| OPTIONAL, | |
| ..., | |
| [[ | |
| applicableFeatures-r18 | ApplicableFeatures-r17 |
| OPTIONAL | |
| ]] | |
| } | |

ApplicableFeatures-r17 SEQUENCE {

| | |
|---|---|
| appliedToMsg3-Repetitions-r17 | ENUMERATED {true} OPTIONAL, - |
| - Need M | |
| appliedToSUL-r17 | ENUMERATED {true} OPTIONAL, -- |
| Need M | |
| appliedToXFeature-r17 | ENUMERATED {true} OPTIONAL, - |
| - Need M | |
| appliedToFurtherFeatures-r17 | ENUMERATED {false, true} |
| } | |

ApplicableFeatures-r18 SEQUENCE {
appliedToMsg3-ExtendedRepetitions-r18 ENUMERATED {true} OPTIONAL,

-- Need M

appliedToMsg1-ExtendedRepetitions-r18 ENUMERATED {true} OPTIONAL, -

- Need M
}
-- TAG-Q-RXLEVMIN-STOP
-- ASN1STOP

The above example highlights how multiple features can be signaled for a q-RxLevMin and how multiple features from multiple releases can be combined for a single threshold and how if for instance extension of certain features are introduced it is clear how the q-RxLevMin shall be calculated.

The above example may be useful if, for instance, further features that extended the coverage are introduced. The above parameter appliedToFurtherFeatures signals whether the configuration also includes features that are not included in a specific release. For example, if the UE is a “Release 17 UE” and does not support any future features, the UE shall not consider the cell access threshold to be valid as there are features included that the UE must support that it cannot interpret.

In alternative embodiments, the configuration can be provided in UE-specific RRC signaling instead of broadcast system information (e.g. in RRC signaling messages).

In the above, the cell selection thresholds q-RxLevMin was used as an example. The q-RxLevMin is the minimum signal level where the UE may connect. Another cell selection threshold is the q-RxQualMin, which is the lowest signal quality level, which considers the signal quality rather than just the signal strength. In another embodiment, the minimum cell quality can be adjusted similar to q-RxLevMin above.

Features that could be useful in order to change the cell access thresholds are features that would change the coverage, or otherwise impact the UE so that the coverage the UE experiences is different compared to other NR UEs not using the said feature. Some examples of features that could be included and used in combination with each other include:

Any type of repetitions during the random access scheme, including future extensions of maximum number of repetitions. For instance, in rel-16 the maximum number of repetitions for msg3 is 16, but in the future, it might be further increased to 32, 64, 128, etc. depending on the required coverage. Thus, among the applicable features can be the msgX repetitions for a specific release.

Supplementary uplink. Supplementary uplink already has its own cell access thresholds in release 15, but here it can be combined with other features.

UE type. If the UE belongs to a specific type, such as drone, vehicular UE or other prioritized UE, then lower access thresholds may be applied.

Repetitions of channels outside of random access, this includes the repetitions of channels such as PDCCH, PDSCH, PUCCH and PUSCH.

In one embodiment, for the repetitions, the network signals that the maximum number of supported repetitions for each random access message (msg1, msg2, msg3 and msg4) defines the q-RxLevMin. For instance, for one q-RxLevMin value, the UE shall support 1 msg1, 1 msg2, 16 msg3 and 1 msg4 repetitions. For CE class 2, the UE shall support 8 msg1, 4 msg2, 16 msg3 and 4 msg4 repetitions. See the following second example Q-RxLevMinEnhanced IE.

```
-- ASN1START
-- TAG-Q-RXLEVMIN-START
Q-RxLevMinEnhanced-r17 ::= SEQUENCE {
    q-RxLevMinValue-r17 INTEGER (-70..-22)
    repetitionLevel-r17 RepetitionLevels-r17
OPTIONAL,
    ...
}
```

| | | | |
|---|---|---|---|
| RepetitionLevels-r17 | SEQUENCE { | | |
| msg1-Repetitions-r17 | INTEGER {1,2,4,8,16,32} | OPTIONAL, | -- Need |
| M | | | |
| msg2-Repetitions-r17 | INTEGER {1,2,4,8,16,32} | OPTIONAL, | -- Need |
| M | | | |
| msg3-Repetitions-r17 | INTEGER {1,2,4,8,16,32} | OPTIONAL, | -- Need |
| M | | | |
| msg4-Repetitions-r17 | INTEGER {1,2,4,8,16,32} | OPTIONAL | -- Need |
| M | | | |
| } | | | |
| -- TAG-Q-RXLEVMIN-STOP | | | |
| -- ASN1STOP | | | |

If there are multiple cell access threshold introduced, then there may be cases where multiple cell access threshold(s) would be supported. In some such embodiments, there can be a selection mechanism by which the UE determines which cell access threshold to apply between multiple supported thresholds. The selection mechanism can be implemented according to the following example embodiments:

1. The UE selects according to a pre-configured priority. In other words, the network can signal a priority order for the cell access thresholds and the UE uses this priority to select one threshold if multiple thresholds are determined to be applicable to the UE. The configuration the network provides to UE can be broadcast system information or a UE specific configuration.

2. A priority order can be defined (e.g. pre-defined) in the specification. This priority order can, for instance, define that thresholds with a single feature are preferred, or that specific features themselves have a priority order. As one example, msg3 repetition could prioritized over msg1 repetition due to the extra required resources for the msg1 repetitions.

3. Selecting the cell access threshold that has the highest value so that the condition remains fulfilled. For instance, if the UE satisfies both threshold1 and threshold2, then the UE would select the threshold that has the highest value and apply the associated configuration.

4. The UE is free to select on its own configuration (UE implementation), for example by:
a) Selecting the best access threshold according to its traffic requirements.
b) Selecting the best access threshold according to power consumption requirements. For instance, if power consumption is to be kept low, the UE would avoid any type of cell where a lot of repetitions would be required as this would quickly drain the batteries.
c) Selecting the best access threshold according to its reliability requirements. If a cell is signaling that it is repetition-capable, then this might be prioritized as the reliability might be more important than anything else.

To enable the above embodiments, a list of feature-based cell access thresholds can be introduced in SIB1, SIB2, SIB3 and/or SIB4 so that the cell access thresholds per feature or feature combination can be shared. Below is an example in the SIB1 message of 3GPP TS 38.331, where maxCEThreshold can be configured by the network, or specified in the specification:

### SIB1 Message

```
-- ASN1START
-- TAG-SIB1-START
[...]
SIB1-r17-IEs ::= SEQUENCE {
    cellSelectionInfo-r17 SEQUENCE {
        q-RxLevMinList SEQUENCE (SIZE
(1..maxCEThreshold)) OF Q-RxLevMinEnhanced-r17
        q-QualMin   Q-QualMin OPTIONAL, --
Need S
      }
    nonCriticalExtension SEQUENCE { } OPTIONAL
}
[...]
-- TAG-SIB1-STOP
-- ASN1STOP
```

### Cell Selection Offsets

In other embodiments, instead of using specific cell access thresholds with an absolute value, offsets can be introduced that apply to specific features. These offsets could either be 1) independently applied to cell selection criteria (see Example A) or, 2) each offset indicates itself which features it applies to (see Example B). The use of these different options could, for instance, be that in some cases the added coverage introduced by a new feature is proportional regardless of other features introduced and in some cases the coverage introduced does not combine well or is non-trivial.

### Example A (3GPP TS 38.304)

$$Srxlev = {Q}_{rxlevmeas} - ( {Q}_{rxlevmin} + {Q}_{rxlevminoffset} - {Q}_{rxlevminoffset \_ feature 1} - {Q}_{rxlevminoffset \_ feature 2} - … ) - {P}_{compensation} - {Qoffset}_{temp} \\ Squal = {Q}_{qualmeas} - ( {Q}_{qualmin} + {Q}_{qualminoffset} - {Q}_{qualminoffset \_ feature 1} - {Q}_{qualminoffset \_ feature 2} - … ) - {Qoffset}_{temp}$$

### Example B (3GPP TS 38.304)

$$Srxlev = {Q}_{rxlevmeas} - ( {Q}_{rxlevmin} + {Q}_{rxlevminoffset} - {Q}_{rxlevminoffset \_ feature \_ set} ) - {P}_{compensation} - {Qoffset}_{temp} \\ Squal = {Q}_{qualmeas} - ( {Q}_{qualmin} + {Q}_{qualminoffset} - {Q}_{qualminoffset \_ feature \_ set} ) - {Qoffset}_{temp}$$

### Example Q-RxLevMinEnhanced IE (3GPP TS 38.331)

-- ASN1START
-- TAG-Q-RXLEVMIN-START

Q-RxLevMinOffset-r17 ::= SEQUENCE {

| | |
|---|---|
| q-RxLevMinOffsetFeature-r17 | INTEGER (20..0) |
| applicableFeatures-r17 | ApplicableFeatures-r17 |
| OPTIONAL, | |
| ..., | |
| [[ | |
| applicableFeatures-r18 | ApplicableFeatures-r17 |
| OPTIONAL | |
| ]] | |
| } | |

ApplicableFeatures-r17 SEQUENCE {

| | |
|---|---|
| appliedToMsg3-Repetitions-r17 | ENUMERATED {true} OPTIONAL, -- Need |
| M | |
| appliedToSUL-r17 | ENUMERATED {true} OPTIONAL, -- Need |
| M | |
| appliedToXFeature-r17 | ENUMERATED {true} OPTIONAL, -- Need |
| M | |
| appliedToFurtherFeatures-r17 | ENUMERATED {false, true} |
| } | |

```
ApplicableFeatures-r18 SEQUENCE {
    appliedToMsg3-ExtendedRepetitions-r18 ENUMERATED {true} OPTIONAL, -
- Need M
    appliedToMsg1-ExtendedRepetitions-r18 ENUMERATED {true} OPTIONAL, -
- Need M
}
-- TAG-Q-RXLEVMIN-STOP
-- ASN1STOP
```

The various embodiments described herein can enable forward compatibility and an efficient way to combine different features for performing cell selection and cell reselection, when the features include, for example, a configurable threshold for determining whether the feature should be used or not.

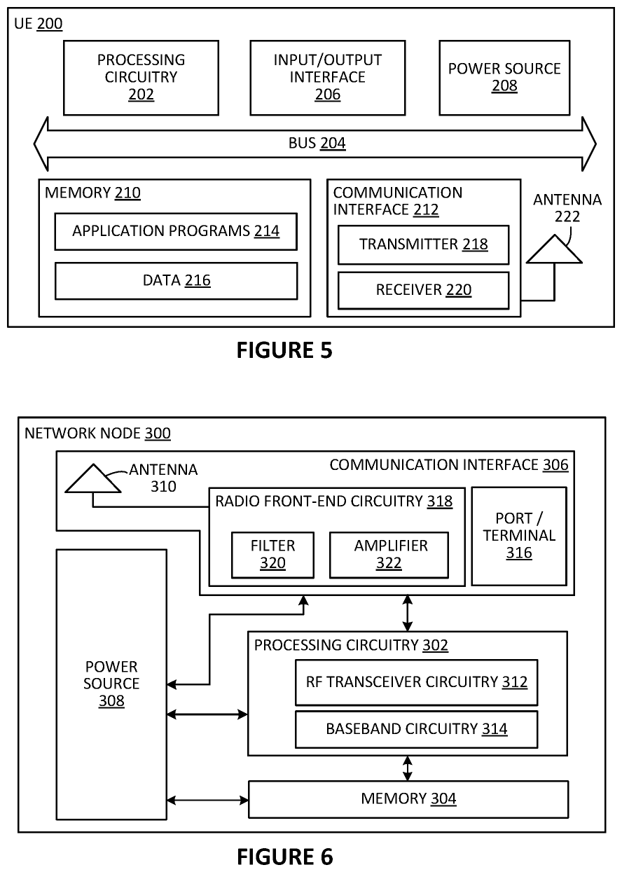

FIG. 5 shows a UE 200, which may be an embodiment of the UE 112 of FIG. 2 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the ULE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 6 shows a network node 300, which may be an embodiment of the access node 110 or the core network node 108 of FIG. 2, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

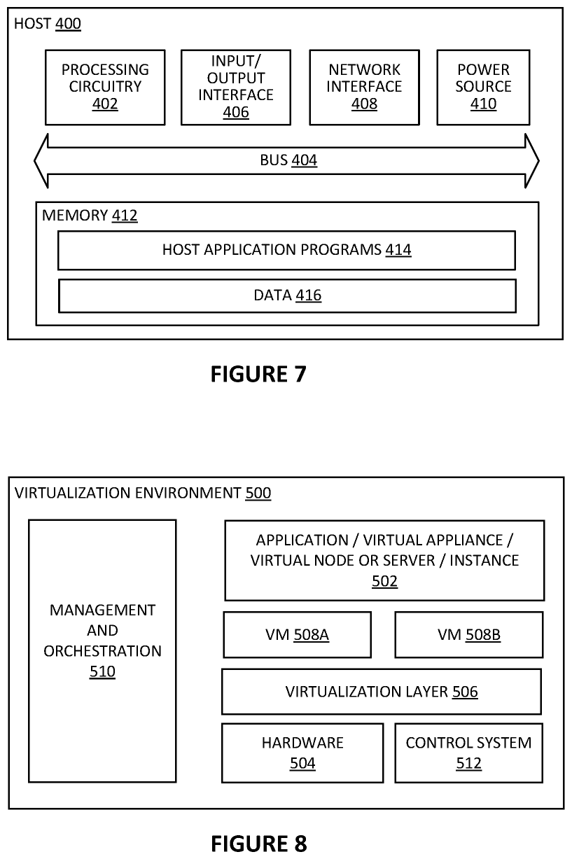

FIG. 7 is a block diagram of a host 400, which may be an embodiment of the host 116 of FIG. 2, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 5 and 6, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

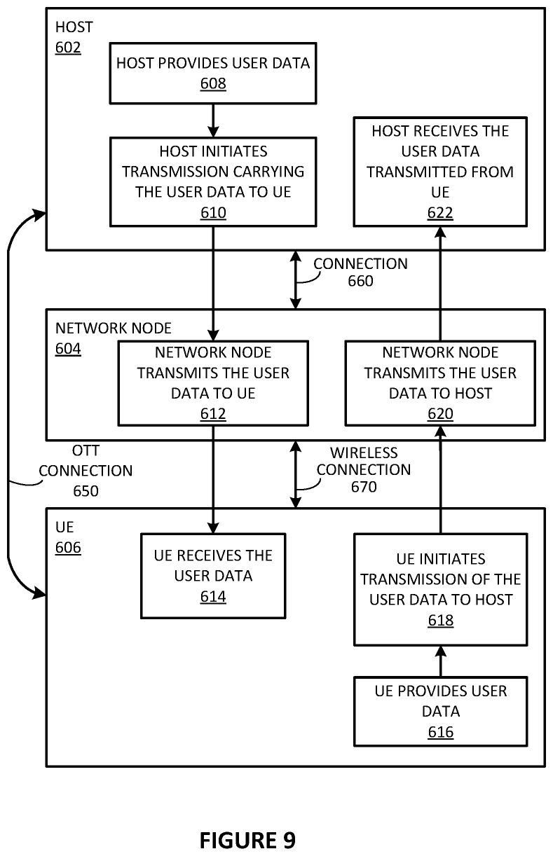

FIG. 9 shows a communication diagram of a host 602 communicating via a network node 604 with a UE 606 over a partially wireless connection in accordance with some embodiments. Example implementations, in accordance with various embodiments, of the UE (such as a UE 112A of FIG. 2 and/or UE 200 of FIG. 5), network node (such as network node 110A of FIG. 2 and/or network node 300 of FIG. 6), and host (such as host 116 of FIG. 2 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the handling of colliding signals and/or channels and thereby provide benefits such as improving measurement latency and bypassing the measurement gap request procedure to improve positioning quality.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6^{th} Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method performed by a wireless device, the method comprising:
receiving configuration information including a plurality of cell access threshold parameters, wherein each parameter indicates a cell access threshold for at least one feature, the configuration information being received in a UE-specific radio resource control (RRC) message;
determining that a first feature associated with a first cell access threshold parameter is supported by the wireless device; and
selecting a cell in accordance with the first cell access threshold parameter.

2. The method of claim 1, wherein the configuration information is received in a system information message.

3. (canceled)

4. The method of claim 1, wherein the first cell access threshold parameter is associated with at least one of: a minimum signal strength allowed on the cell, and a minimum signal quality allowed on the cell.

5. The method of claim 1, wherein the first cell access threshold parameter is associated with at least one of: a number of repetitions of a message within a random access procedure, a number of repetitions of message in a channel outside of random access, a wireless device type, and a supplementary uplink (SUL) access threshold.

6. The method of claim 1, wherein the first cell access threshold parameter is an offset value.

7. The method of claim 1, wherein multiple features are associated with the first cell access threshold parameter.

8. The method of claim 7, wherein the multiple features are associated with multiple specification releases.

9. The method of claim 1, wherein determining that the first feature associated with the first cell access threshold parameter is supported by the wireless device includes comparing the received plurality of cell access threshold parameters to a set of supported features of the wireless device.

10. The method of claim 1, further comprising, determining that multiple cell access threshold parameters are supported by the wireless device.

11. The method of claim 10, further comprising, selecting the first cell access threshold parameter from the multiple supported cell access threshold parameters.

12. The method of claim 11, wherein the first cell access threshold parameter is selected in accordance with a priority order.

13. The method of claim 11, wherein the first cell access threshold parameter is selected in accordance with the first cell access threshold parameter having a highest value such that a condition is fulfilled.

14. The method of claim 11, wherein the first cell access threshold parameter is selected in accordance with at least one of: a traffic requirement, a power consumption requirement, and a reliability requirement.

15. (canceled)

16. A wireless device comprising a radio interface and processing circuitry configured to:
receive configuration information including a plurality of cell access threshold parameters, wherein each parameter indicates a cell access threshold for at least one feature, the configuration information being received in a UE-specific radio resource control (RRC) message;
determine that a first feature associated with a first cell access threshold parameter is supported by the wireless device; and
select a cell in accordance with the first cell access threshold parameter.

17.-30. (canceled)

31. A method performed by a network node, the method comprising:
generating configuration information including a plurality of cell access threshold parameters, wherein each parameter indicates a cell access threshold for at least one feature; and
transmitting, to a wireless device, the configuration information including a plurality of cell access threshold parameters, the configuration information being transmitted in a UE-specific radio resource control (RRC) message.

32. The method of claim 31, wherein the configuration information is transmitted in a system information message.

33. (canceled)

34. The method of claim 31, wherein the first cell access threshold parameter is associated with at least one of: a minimum signal strength allowed on the cell and a minimum signal quality allowed on the cell.

35. The method of claim 31, wherein the first cell access threshold parameter is associated with at least one of: a number of repetitions of a message within a random access procedure, a number of repetitions of message in a channel outside of random access, a wireless device type, and a supplementary uplink (SUL) access threshold.

36. The method of claim 31, further comprising, receiving, from the wireless device, a request for configuration information.

37. A network node comprising a radio interface and processing circuitry configured to:
generate configuration information including a plurality of cell access threshold parameters, wherein each parameter indicates a cell access threshold for at least one feature; and
transmit, to a wireless device, the configuration information including a plurality of cell access threshold parameters, the configuration information being received in a UE-specific radio resource control (RRC) message.

38.-42. (canceled)
